(19) United States
(12) Patent Application Publication
(10) Pub. No.: US 2021/0091360 A1
(43) Pub. Date: Mar. 25, 2021

(54) BATTERY PACK WITH ATTACHED SYSTEM MODULE

(71) Applicant: Apple Inc., Cupertino, CA (US)

(72) Inventors: Haran Balaram, Sunnyvale, CA (US); Nathan J. Bohney, Campbell, CA (US); Pengchuan Wang, San Jose, CA (US)

(73) Assignee: Apple Inc., Cupertino, CA (US)

(21) Appl. No.: 16/582,461

(22) Filed: Sep. 25, 2019

(51) Int. Cl. H01M 2/20; H01M 2/10; H01M 2/26

(52) U.S. Cl. CPC H01M 2/202; H01M 2/266; H01M 2/1077

(57) ABSTRACT

Battery systems according to embodiments of the present technology may include a battery. The battery may include a first electrode terminal and a second electrode terminal accessible along a first surface of the battery. The systems may include a module electrically coupled with the battery. The module may include a circuit board characterized by a first surface and a second surface opposite the first surface. The module may include a mold extending from the first surface of the circuit board toward the battery. The module may include a first conductive tab electrically coupling the module with the first electrode terminal. The module may include a second conductive tab electrically coupling the module with the second electrode terminal. The second conductive tab may extend across the mold substantially parallel to the first surface of the circuit board.

### TECHNICAL FIELD

The present technology relates to battery systems. More specifically, the present technology relates to battery component configurations incorporating a module with a battery.

### BACKGROUND

Batteries are used in many devices. As devices in which batteries are housed reduce in size, the available space for battery cells and associated system materials may limit placement options.

### SUMMARY

Battery systems according to embodiments of the present technology may include a battery. The battery may include a first electrode terminal and a second electrode terminal accessible along a first surface of the battery. The systems may include a module electrically coupled with the battery. The module may include a circuit board characterized by a first surface and a second surface opposite the first surface. The module may include a mold extending from the first surface of the circuit board toward the battery. The module may include a first conductive tab electrically coupling the module with the first electrode terminal. The module may include a second conductive tab electrically coupling the module with the second electrode terminal. The second conductive tab may extend across the mold substantially parallel to the first surface of the circuit board.

In some embodiments, the battery may include a port positioned proximate a lateral edge of the first surface of the battery. The second conductive tab may extend between the mold and the port. The systems may include a first adhesive positioned between the second conductive tab and the mold proximate the port. The first conductive tab may extend beyond a first lateral edge of the module. The second conductive tab may extend beyond a second lateral edge of the module opposite the first lateral edge of the module. The first conductive tab and the second conductive tab may extend from the second surface of the module. The second conductive tab may extend about the second lateral edge of the module and wrap across the mold towards the second electrode terminal. The first electrode terminal may extend proud of the first surface of the battery towards the first surface of the circuit board. The first conductive tab may extend past a plane of the second surface of the circuit board to couple with the first electrode terminal. An electronic device may extend from the first surface of the circuit board towards the battery. The circuit board may extend substantially parallel to the first surface of the battery to a location proximate the first electrode terminal. The systems may include an adhesive extending across the module. A first end of the adhesive and a second end of the adhesive may be coupled with the battery. The adhesive may include an insulation along a portion of the adhesive, and wherein the insulate extends from a first end of the adhesive across the first electrode terminal. The systems may include a flexible coupling extending from the module and including a board-to-board connector at a distal end of the flexible coupling.

Some embodiments of the present technology may encompass battery systems. The systems may include a battery characterized by a first surface, a second surface, and a third surface. The second surface and the third surface may be substantially parallel to one another. The first surface of the battery may extend between the second surface and the third surface. The first surface may include a first electrode terminal and a second electrode terminal. The systems may include a module coupled with the first surface of the battery and including a circuit board characterized by a first surface and a second surface opposite the first surface. The module may include a mold extending from the first surface of the circuit board toward the battery. The module may include a first conductive tab extending from the second surface of the circuit board to the first electrode terminal. The module may include a second conductive tab extending from the second surface of the circuit board to the second electrode terminal. The module may include a flexible coupling extending from the second surface of the circuit board.

In some embodiments, the mold may extend laterally parallel with the first surface of the battery. The first electrode terminal of the battery may extend from the first surface of the battery. The mold may be maintained between the first electrode terminal of the battery and a lateral edge of the battery. The second conductive tab may extend about a lateral edge of the module and wrap across the mold towards the second electrode terminal. The second conductive tab may be coupled with the mold by a first adhesive. The second conductive tab may be coupled with the battery by a second adhesive. The second surface of the battery may include a flange extending proud of an intersection of the first surface of the battery and the second surface of the battery. The circuit board of the module may extend substantially parallel to the first surface of the battery between the flange and the third surface of the battery. The module may extend across the second electrode terminal of the battery. The circuit board may include test points accessible on the second surface of the circuit board. The flexible coupling may include a connector at a distal end of the flexible coupling. The flexible coupling may be coupled with the second surface of the circuit board at a proximal end of the flexible coupling.

Some embodiments of the present technology may encompass battery systems. The systems may include a battery. The battery may include a first electrode terminal, a second electrode terminal, and a port accessible along a first surface of the battery. The systems may include a module electrically coupled with the battery. The module may include a mold extending toward the battery. The mold may extend across the second electrode terminal and the port between the first electrode terminal and a lateral edge of the battery. The module may include a first conductive tab electrically coupling the module with the first electrode terminal. The module may include a second conductive tab electrically coupling the module with the second electrode terminal. The second conductive tab may extend from a surface of the module opposite the mold. The second conductive tab may extend about a lateral edge of the module across the mold and between the mold and the battery. The systems may include a flexible coupling extending from the module from a surface of the module opposite the mold. The system may include an adhesive positioned between the mold and the second conductive tab.

Such technology may provide numerous benefits over conventional technology. For example, the present systems may provide a compact positioning of battery system components with a battery. Additionally, the battery system components may be positioned to accommodate a defined volume and geometry of a battery. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic cross-sectional view of a battery cell according to some embodiments of the present technology.

FIG. 2 shows a schematic plan view of a battery system according to some embodiments of the present technology.

FIG. 3 shows a schematic elevation view of a battery system according to some embodiments of the present technology.

FIG. 4 shows a schematic, cross-sectional, partial top view of a battery system according to some embodiments of the present technology.

FIG. 5 shows a schematic partial side elevation view of a battery system according to some embodiments of the present technology.

FIG. 6 shows a schematic view of a module including conductive tabs according to some embodiments of the present technology.

Several of the figures are included as schematics. It is to be understood that the figures are for illustrative purposes, and are not to be considered of scale or proportion unless specifically stated to be of scale or proportion. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Batteries, battery cells, and more generally energy storage devices, are used in a host of different systems. In many devices, the battery cells may be designed with a balance of characteristics in mind. For example, including larger batteries may provide increased usage between charges, however, the larger batteries may require larger housing, or increased space within the device. As device designs and configurations change, especially in efforts to reduce device sizes, the available space for additional battery system components may be constrained. These constraints may include restrictions in available volume as well as the geometry of such a volume. Conventional devices have often been restricted to larger form factors to accommodate both a sufficient battery as well as associated battery system components. The present technology may overcome these issues, however, by providing a configuration by which battery control system components may be confined to a volume accommodating the battery or a battery system in one or more ways. After illustrating an exemplary cell that may be used in embodiments of the present technology, the present disclosure will describe battery system designs having a controlled form factor for use in a variety of devices in which battery cells may be used.

Although the remaining portions of the description will reference lithium-ion batteries, it will be readily understood by the skilled artisan that the technology is not so limited. The present techniques may be employed with any number of battery or energy storage devices, including other rechargeable and primary battery types, as well as secondary batteries, or electrochemical capacitors. Moreover, the present technology may be applicable to batteries and energy storage devices used in any number of technologies that may include, without limitation, phones and mobile devices, watches, glasses, bracelets, anklets, and other wearable technology including fitness devices, handheld electronic devices, laptops and other computers, as well as other devices that may benefit from the use of the variously described battery technology.

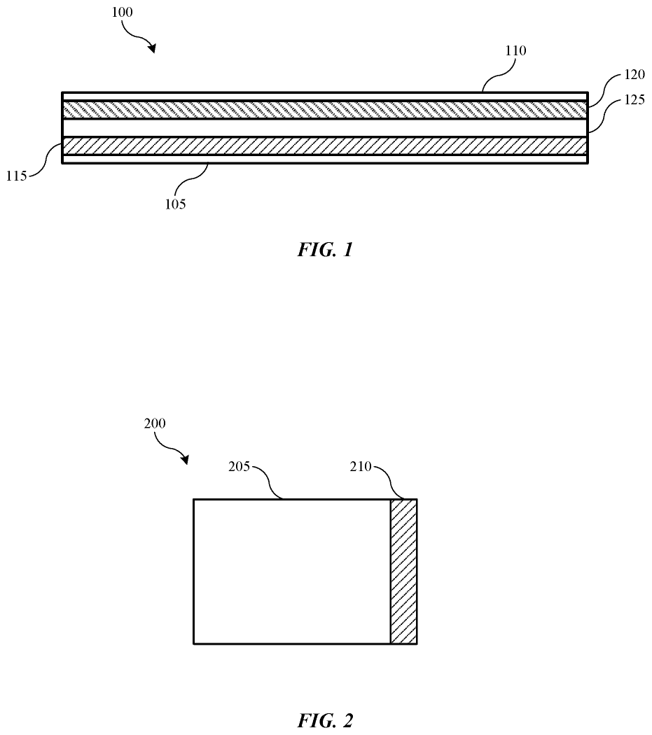

FIG. 1 depicts a schematic cross-sectional view of an energy storage device or battery cell 100 according to embodiments of the present technology. Battery cell 100 may be or include a battery cell, and may be one of a number of cells coupled together to form a battery structure. As would be readily understood, the layers are not shown at any particular scale, and are intended merely to show the possible layers of cell material of one or more cells that may be incorporated into an energy storage device. In some embodiments, as shown in FIG. 1, battery cell 100 includes a first current collector 105 and a second current collector 110. In embodiments one or both of the current collectors may include a metal or a non-metal material, such as a polymer or composite that may include a conductive material. The first current collector 105 and second current collector 110 may be different materials in embodiments. For example, in some embodiments the first current collector 105 may be a material selected based on the potential of an anode active material 115, and may be or include copper, stainless steel, or any other suitable metal, as well as a non-metal material including a polymer. The second current collector 110 may be a material selected based on the potential of a cathode active material 120, and may be or include aluminum, stainless steel, or other suitable metals, as well as a non-metal material including a polymer. In other words, the materials for the first and second current collectors can be selected based on electrochemical compatibility with the anode and cathode active materials used, and may be any material known to be compatible.

In some instances the metals or non-metals used in the first and second current collectors may be the same or different. The materials selected for the anode and cathode active materials may be any suitable battery materials operable in rechargeable as well as primary battery designs. For example, the anode active material 115 may be silicon, graphite, carbon, a tin alloy, lithium metal, a lithium-containing material, such as lithium titanium oxide (LTO), or other suitable materials that can form an anode in a battery cell. Additionally, for example, the cathode active material 120 may be a lithium-containing material. In some embodiments, the lithium-containing material may be a lithium metal oxide, such as lithium cobalt oxide, lithium manganese oxide, lithium nickel manganese cobalt oxide, lithium nickel cobalt aluminum oxide, or lithium titanate, while in other embodiments the lithium-containing material can be a lithium iron phosphate, or other suitable materials that can form a cathode in a battery cell.

The first and second current collectors as well as the active materials may have any suitable thickness. A separator 125 may be disposed between the electrodes, and may be a polymer film or a material that may allow lithium ions to pass through the structure while not otherwise conducting electricity. Active materials 115 and 120 may additionally include an amount of electrolyte in a completed cell configuration. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example.

In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities, such as greater than or about 5⁻¹⁰ mS/cm.

Although illustrated as single layers of electrode material, battery cell 100 may be any number of layers. Although the cell may be composed of one layer each of anode and cathode material as sheets, the layers may also be formed into a jelly roll design, or folded design, prismatic design, or any form such that any number of layers may be included in battery cell 100. For embodiments which include multiple layers, tab portions of each anode current collector may be coupled together, as may be tab portions of each cathode current collector. Once the cell has been formed, a pouch, housing, or enclosure may be formed about the cell to contain electrolyte and other materials within the cell structure, as will be described below. Terminals may extend from the enclosure to allow electrical coupling of the cell for use in devices, including an anode and cathode terminal. The coupling may be directly connected with a load that may utilize the power, and in some embodiments the battery cell may be coupled with a control module that may monitor and control charging and discharging of the battery cell. FIG. 1 is included as an exemplary cell that may be incorporated in battery systems according to the present technology. It is to be understood, however, that any number of battery and battery cell designs and materials that may include charging and discharging capabilities similarly may be encompassed by the present technology.

FIG. 2 shows a schematic plan view of a battery system 200 according to some embodiments of the present technology. As illustrated, battery system 200 may include a battery cell or battery 205, which may include any number of battery cells, as well as a battery module 210. Battery module 210 may be electrically connected with battery 205 to provide a variety of functionality. For example, battery module 210 may monitor battery 205 during charging and discharging operations, and may ensure the battery is not overcharged or over-depleted during use. Additionally, battery module 210 may monitor overall health of the battery 205 to ensure proper functioning. Battery module 210 may couple with terminals of the battery, such as one or both of the positive and negative terminals, in order to provide this functionality.

Battery module 210 may also include an additional electrical connector, such as a coupling, that may allow device components to access the battery capacity through the battery module 210. In this way, battery module 210 may provide a pass-through functionality for delivering power from battery 205. Consequently, battery module 210 may be under constant load from the battery. Battery 205 may include a battery cell, which may be similar to battery cell 100 described above, and may include a pouch or enclosure to protect the battery cell from exposure to the environment. The housing may also operate to maintain electrolyte and other materials within the battery cell. To access the battery cell through this housing, one or more terminals or leads may extend through the housing. Some conventional designs may wrap the battery module 210 onto the terminals of battery 205, which may allow the provision of additional materials to protect terminals and conductive components from fluid contact. However, as device configurations continue to shrink, battery designs change, and manufacturing processes incorporate many more small scale operations with smaller and/or thinner materials, these types of incorporations may become less feasible or prone to causing damage. The present technology allows for an adjacent coupling of the battery module 210 onto terminals of the battery 205, which may further reduce the overall battery system envelope when incorporated within an electronic device.

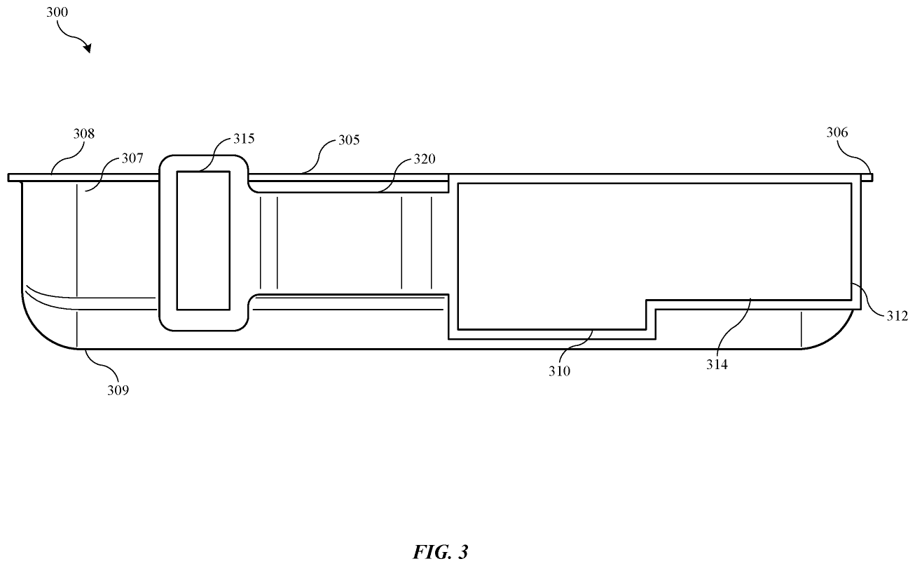

FIG. 3 shows a schematic cross-sectional view of a battery system 300 according to some embodiments of the present technology. Battery system 300 may include any of the components previously described, and may include a battery 305, and a module 310. Battery 305 may include a battery cell as previously described in FIG. 1, and may include one or more cells included within a pouch or packaging. For example, in some embodiments battery 305 may include a rigid housing, and may include a conductive housing. The conductive housing may be maintained at positive or negative potential in embodiments, and may be maintained at negative potential, which may then operate as a device ground, and be considered similar to a neutral connection. Additionally, by using a rigid housing instead of a flexible pouch, fabrication tolerances on the battery dimensions may be reduced, which may afford increased volume for the internal battery cells, which may provide increased capacity over conventional designs. The rigid housing or can may include a flange 306 extending about the battery 305, which may be a lid enclosure for the rest of the housing, and which may be or include a seamless or substantially seamless form providing an internal volume in which the battery cell or cells and electrolyte may be contained.

Module 310 may monitor and manage aspects of battery 305 operation, and may be a power control module in embodiments. Module 310 may electrically couple with electrode terminals of the battery 305, and may transfer power through connector 315, which may be any type of connector, such as a board-to-board connector, for example. In some embodiments, module 310 may be at least partially contained within the lateral dimensions of battery 305, and may be partially maintained within a width of the battery 305. The connector 315 may be part of a coupling 320, which may be a flexible coupling extending from the module 310. For example, connector 315 may be at or near a distal end of the coupling 320. Coupling 320 may partially extend beyond a lateral dimension of the battery 305 as illustrated, although coupling 320 may be flexible and when incorporated within a device, may be moveable within a particular volume. Module 310, however, may be partially or fully contained within the lateral width of the battery 305 in some embodiments. Module 310 may include one or more components including a circuit board 312 as well as a mold 314, which may include a single mold extending across the circuit board 312, as well as multiple portions in embodiments including discrete portions separately coupled with the circuit board 312, as will be explained further below. Coupling 320 may extend from the circuit board and be folded in one or more ways to position the connector 315 beneath the module 310, or in an additional position as may be explained further below. Of course, the position may be relative to the orientation of the battery system 300.

For example, battery 305 may have a first surface 307, which may be a surface adjacent to or facing module 310 in embodiments. Battery 305 may include a second surface 308 from which flange 306 may extend, and battery 305 may include a third surface 309 opposite second surface 308. First surface 307 may extend between and be partially or substantially normal to second surface 308 and/or third surface 309. By substantially is meant that angles may be less than or greater than perfectly perpendicular, which may account for curved surfaces as well as machining or fabrication tolerances. As previously noted, the housing of battery 305 may include a recessed can on which a lid is disposed, and thus in some embodiments first surface 307 and third surface 309 may be part of a continuous structure and may not have a discrete intersection. Similarly, flange 306 may be formed by material extending from the first surface as well as material defining the second surface, such as where first surface 307 may define a lip at an edge along which a lid, being the second surface, may be coupled. Regardless, the flange may extend in line with the second surface in embodiments.

Returning to coupling 320, when folded, connector 315 may be positioned at least partially in line with module 310 along first surface 307 of battery 305, although the connector 315 may be positioned at least partially between the module 310 and the third surface 309, as well as at least partially extending past third surface 309 in a direction at least partially along or parallel with the first surface 307 of the battery between the second and third surfaces. The coupling may be a number of flexible couplings including printed circuit board, flex board, or other circuit materials or cables that may allow electrical transmission as well as communication transmission to and from the individual circuit modules or the battery to a system board.

The coupling 320 may be folded in multiple ways depending on an electronic device configuration to properly position the connector. For example, in one non-limiting embodiment illustrated, coupling 320 may extend from circuit board 312 in a direction substantially parallel with first surface 307 towards a lateral edge of battery 305. Again, by substantially is meant the components may not be perfectly parallel with one another, but may generally run in a similar direction, and is to be understood in the same manner throughout the present disclosure. Coupling 320 may include a number of folds as will be described in further detail below. The coupling may include one or more arcuate sections extending the coupling in planes towards or away from portions of the battery or module, which may account for geometries and configurations related to disposing the system within an electronic device. It is to be understood that coupling 320 may take a variety of forms to properly position a connector for coupling depending on location of the component to be connected, and FIG. 3 illustrates merely one example of a coupling 320 configuration.

Adhesives may be included to at least partially hold module 310 against battery 305, as will be described further below. The adhesives may be one of several adhesives incorporated to maintain module 310 with battery 305, as will be described in more detail below.

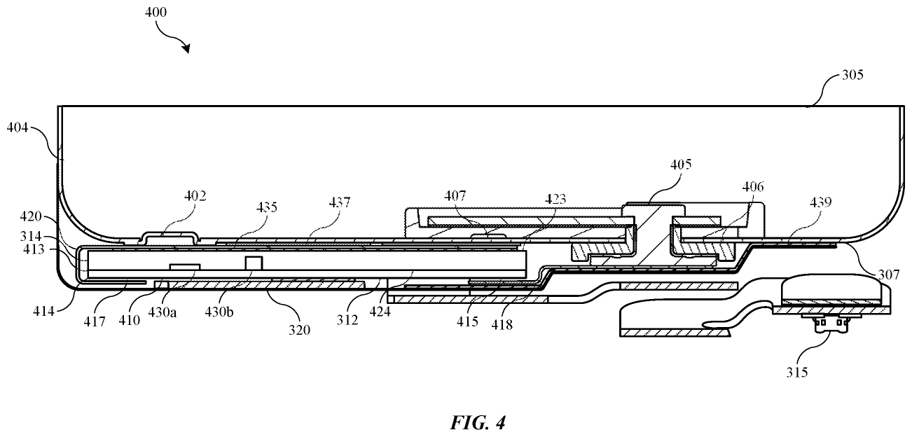

FIG. 4 shows a schematic, cross-sectional, partial, top view of a battery system 400 according to some embodiments of the present technology. As shown in FIG. 4, battery system 400 may include some or all of the components, characteristics, or aspects of battery cells or systems described above, although some aspects may be adjusted to illustrate additionally encompassed embodiments of the present technology. For example, battery system 400 in this view shows battery 305 and module 410. Additional aspects of both the battery 305 and module 410 are shown including multiple locations for electrical and or mechanical coupling of the components. Module 410 may include any of the features of characteristics of module 310 described above, although module 410 may be positioned with the flex coupling extending in a separate direction, and the module facing the battery according to some embodiments of the present technology. The present technology may utilize any number of module designs, and in some embodiments may include a system-in-package module, which may improve device dimensions over other schemes. For example, a system-in-package module may incorporate multiple integrated circuits on a single carrier substrate or board. This may afford compact device placement and wiring compared to conventional designs. Such a configuration may incorporate components of the module to be incorporated on a single side of the module to reduce the module footprint as will be explained further below.

Battery 305 may include one or more terminals extending from battery 305 and providing electrical access to the battery cell. Additionally, a port 402 may be positioned along the first surface 307 of battery 305. Port 402 may be a fill port or other access to battery 305, and may be sealed in some embodiments. Port 402 may be positioned proximate a lateral edge of battery 305 or first surface 307 of battery 305, such as near or adjacent a fourth surface 404 of battery 305 that may intersect or extend into a lateral edge of first surface 307 of battery 305.

A first electrode terminal 405 and a second electrode terminal 407 may extend from or be accessible along first surface 307 of battery 305. In some embodiments each of the first electrode terminal and the second electrode terminal may extend from the first surface 307 of battery 305 to the same position. In some embodiments, such as illustrated, first electrode terminal 405 may extend outward from first surface 307 further than second electrode terminal 407. As previously noted, in some embodiments the housing of battery 305 may be conductive and may be at the potential of one of the electrodes, such as the anode terminal, although the housing may also be maintained at cathode potential. The second electrode terminal 407 may represent the electrode terminal of the potential at which the housing is maintained. Accordingly, the terminal may be a contact, tab, or access of the housing. The first electrode terminal 405, however, may be at the opposite potential of the housing and/or the second electrode terminal 407, and may be maintained or electrically isolated from the rest of the housing. For example, first electrode terminal 405 may be the cathode terminal, although the terminal may also be maintained at anode potential in other embodiments.

To isolate the first electrode terminal 405 from the rest of the housing, a spacer 406 may extend circumferentially about the first electrode terminal through the housing of battery 305, including along the first surface 307 of battery 305. Consequently, first electrode terminal 405 may extend further than second electrode terminal 407. In order to limit the extensions of the module to accommodate this configuration, in some embodiments the module 410 may include different conductive tabs as well as a lateral spatial offset of the module to accommodate the spatial offset of the two terminals.

Module 410 may be electrically coupled with battery 305 at both the first electrode terminal and the second electrode terminal. As noted, module 410 may include a circuit board 312 as well as a mold 314. The circuit board 312 may be characterized by a first surface 413 and a second surface 414 opposite the first surface. Mold 314 may extend from a first surface 413 of the circuit board 312 towards the battery 305, such as towards first surface 307 of the battery 305. Mold 314 may, similar to the circuit board and overall module 410, extend laterally parallel or substantially parallel with the first surface 307 of battery 305, and may be maintained along with circuit board 312 between first electrode terminal 405 and a lateral edge of the battery, such as surface 404. Module 410 may extend across port 402 as well as second electrode terminal 407 in some embodiments. A first contact 415 and a second contact 417 may be included on second surface 414 to electrically couple the module with the battery 305. Extending between and electrically coupling the first contact 415 with the first electrode terminal 405 may be a first conductive tab 418. Extending between and electrically coupling the second contact 417 with the second electrode terminal 407 may be a second conductive tab 420. These connections will be described in further detail below.

Module 410 may also include mold 314 which may extend across the circuit board 312 in embodiments. In some embodiments as illustrated, mold 314 may extend fully across circuit board 312 along the first surface 413. For example, mold 314 may include a first surface 423 and a second surface 424 coupled with the first surface 413 of the circuit board. Mold 314 may extend from the circuit board 312 towards the battery 305 or towards the first surface 307 of battery 305 as noted. Circuit board 312 may include one or more electronic devices 430 or components extending from either or both of the first surface 413 or the second surface 414 of the circuit board, some of which may be encapsulated by mold 314. For example, electronic device 430a and 430b are illustrated as extending from the first surface 413 of circuit board 312. The devices 430 are encapsulated by mold 314, which may provide protection for the electronic devices. Additional aspects of the components of circuit board 312, such as accessible aspects for diagnostics, will be described further below.

Coupling 320 may also extend or be coupled with second surface 414 of circuit board 312. Coupling 320 may be electrically coupled with the circuit board in a location between first conductive tab 418 and second conductive tab 420. The coupling may be connected with the second surface of the circuit board at a proximal end of the coupling and may extend any number of ways to a distal end of the coupling at which connector 315 may be disposed.

Returning to the conductive tabs electrically coupling the module 410 with the battery 305, first conductive tab 418 may extend from a first lateral edge of module 410, and from second surface 414 of circuit board 312. The conductive tab may extend laterally towards first electrode terminal 405, and may be sealed, welded, or otherwise electrically coupled with the first electrode terminal. As illustrated, first electrode terminal 405 may extend outward from or proud of first surface 307 of battery 305 beyond a plane extending along first surface 423 of mold 314. First electrode terminal 405 may also extend to or towards first surface 413 of circuit board 312. First conductive tab 418 may include a recessed bend or jog as illustrated, which may extend the first conductive tab from a first plane in line with the second surface of the circuit board to a second plane parallel with the first, and in line with an exterior or coupling surface of the first electrode terminal 405.

Second conductive tab 420 may extend a greater distance than first conductive tab 418 in some embodiments. Second conductive tab 420 may extend from a second lateral edge of module 410, which may be opposite the first lateral edge from which first conductive tab 418 may extend. Second conductive tab 420 may also extend from the second surface 414 of circuit board 312. Once clearing the external lateral edge of module 410, such as proximate surface 404 of battery 305, second conductive tab 420 may bend along module 410 in a direction orthogonal to first surface 307 of the battery, as well as first surface 413 of circuit board 312. Once clearing first surface 423 of mold 314, the second conductive tab 420 may again bend along module 410 in a direction substantially parallel to first surface 307 of battery 305, and may extend back across from an initial direction of extension. For example, from a proximal end of conductive tab 420 extending from the circuit board, the tab may extend in a first direction to the exterior edge of module 410 and extending back about 180° along a front surface of the module facing the battery. Second conductive tab 420 may wrap around a lateral edge of the module as illustrated towards the second electrode terminal. A distal end of second conductive tab 420 may then be welded, joined, or otherwise electrically coupled with second electrode terminal 407.

As illustrated, second conductive tab 420 may extend between the module 410 or mold 314 and the first surface 307 of the battery. Second conductive tab 420 may extend between mold 314 and port 402. As noted above, multiple adhesives may be included both for component protection and positioning. Although any number of adhesives may be included for cosmetic and/or coupling purposes, a few adhesives may be included in some embodiments of the present technology. A first adhesive 435 may be positioned between the second conductive tab and a first surface 423 of the mold 314. First adhesive 435 may extend from a first position near the second lateral edge of the module, such as proximate port 402, to a second position near the first lateral edge of the module, such as proximate second conductive tab 407.

Adhesive 435, along with any of the adhesives described elsewhere, may be any number of adhesives, and in some embodiments may provide environmental protection and/or insulation along with coupling. While in some embodiments the adhesives are water resistant, in other embodiments the adhesives may be configured to simply protect the components from any environmental contaminants including dust, lint, or other particulates, and insulate the components against contact. Additionally, the adhesives may be configured to maintain a location of the module 410 relative to the battery 305. The adhesives may be or include a polymer backing with an applied adhesive. The polymer may be any number of polymers that provide electrical resistivity, structural resiliency, hydrophobicity, or flexibility. For example, in some embodiments a polyimide-backed tape may be used, which may afford a thin film tape that may be flexible to accommodate the topography of module 310, while limiting gaps or spacing about the module. Although described as a tape, additional adhesives, encapsulants, and enclosures may be utilized to provide a similar protection to components of the module 410, and are similarly encompassed by the present technology.

For example, adhesive 435 may include an amount of insulation with the adhesive to protect both mold 314 as well as second conductive tab 420. A second adhesive 437 may also be coupled with second conductive tab 420, such as on a second surface of the second electrode tab opposite a first surface with which first adhesive 435 may couple the second electrode tab with mold 314. Second adhesive 437 may couple second conductive tab 420 with first surface 307 of battery 305, which may at least partially secure the module 410 to the battery 305. Second adhesive 437 may extend between port 402 and second electrode terminal 407 in some embodiments. A third adhesive 439 may further secure the module 410 with battery 305. As illustrated, third adhesive 439 may extend across module 410 and couple with battery 305 at a first end and a second end of the adhesive.

For example, a first end of third adhesive 439 may couple with first surface 307 of battery 305, although the adhesive may also extend about an edge of the battery and wrap around an edge of first surface 307. Third adhesive 439 may extend across module 410, and a second end of third adhesive 439 may couple with surface 404 of battery 305. Third adhesive 439 may also include an amount of insulation along a portion of the adhesive. For example, insulation may extend from the first end of the adhesive to a position across first conductive tab 418, before the insulation is halted. The insulation may extend across a portion of the adhesive in contact with the first conductive tab 418, and may fully extend across first conductive tab 418, which may further protect the tab, which may be at cathode potential.

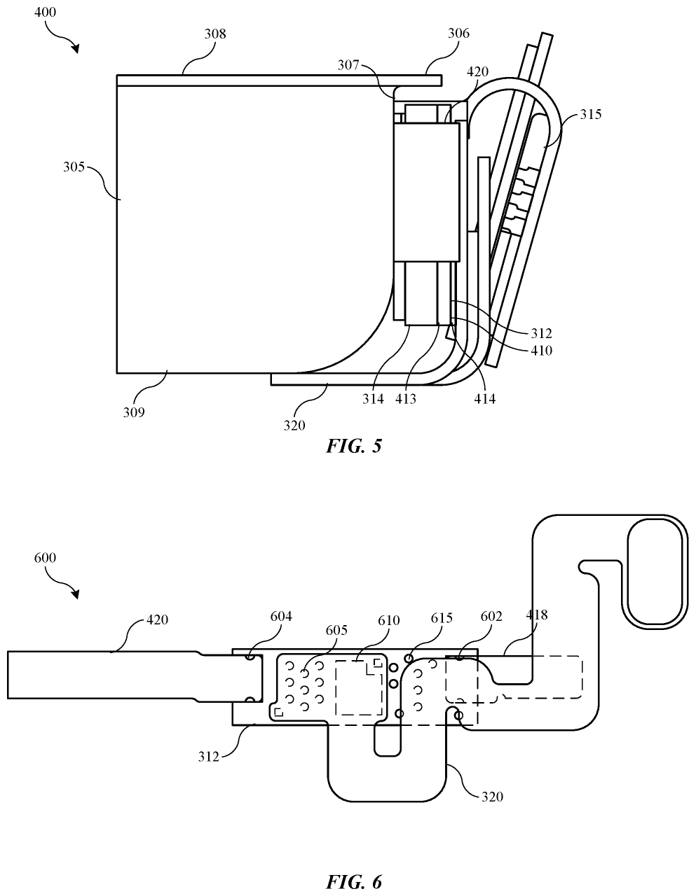

Turning to FIG. 5 is shown a schematic partial side elevation view of battery system 400 according to some embodiments of the present technology. As shown in FIG. 5, battery system 400 may include some or all of the components, characteristics, or aspects of battery system 400 described previously. For example, battery system 400 in this view shows battery 305 and module 410. Additional aspects of both the battery 305 and module 410 are shown including additional aspects of some embodiments of flexible coupling 320.

As previously discussed, battery 305 may include a flange 306 extending outward from or proud of second surface 308 outwardly beyond first surface 307. The illustrated view of module 410 may show circuit board 312, mold 314, and second conductive tab 420 extending about or wrapping around the circuit board and mold of the module 410. As illustrated, module 410, without coupling 320 in some embodiments, may be maintained between second surface 308 and third surface 309 of battery 305, and may at least partially reside between flange 306 and third surface 309 of the battery 305. Circuit board 312 and mold 314 may each extend substantially parallel to first surface 307 of battery 305 and may at least partially recess beyond flange 306 towards first surface 307. For example, flange 306 may extend out from first surface 307 past mold 314, and may extend to or beyond a plane of first surface 413 of circuit board 312. Flange 306 may extend fully past circuit board 312, or may extend at least partially past first surface 413 of circuit board 312 in some embodiments towards or beyond second surface 414 of circuit board 312. By at least partially recessing module 410 within a volume or envelope of the battery 305, less space within an electronic device may be consumed by the battery power module.

The figure also illustrates an additional configuration of coupling 320, which may extend from second surface 414 of circuit board 312 in a direction towards third surface 309 of battery 305. Although any number of coupling geometries are encompassed by the present technology as previously described, in some embodiments, flex coupling 320 may bend or extend back across module 410 as illustrated, and may extend to or towards battery 305. In some embodiments, coupling 320 may extend past a plane of first surface 307 and extend across and may contact third surface 309 of battery 305. The coupling may curve back out past first surface 307 and may include one or more additional curves before reaching a distal end of coupling 320 at which connector 315 may be coupled.

FIG. 6 shows a schematic view of a module 600 including conductive tabs according to some embodiments of the present technology. It is to be understood that any number of conductive materials or tab geometries may be used in the present technology, and thus the example of module 600 is not intended to limit the present technology. Module 600 may include some or any of the components of module 310 or 410 described above, and may include a circuit board 312. Circuit board 312 may include a first contact 602 and a second contact 604, which may be electrically coupled with electrode terminals on a battery as previously described. A first conductive tab 418 may be coupled with and extend from first contact 602, and a second conductive tab 420 may be coupled with and extend from second contact 604.

The conductive tabs may include a variety of geometries providing a surface for coupling with electrode tabs of a battery. Although conductive tabs 418 and 420 may be rectangular, in some embodiments the conductive tabs may be characterized by any number of geometries that may be shaped to accommodate contacts or terminals of virtually any shape. A first end and second end of each conductive tab may be or form a weld tab, which may provide a landing space and surface to which electrode tabs may be welded, bonded, or otherwise adhered to an associated contact or terminal. The conductive tabs may also include an extension portion between the first end and second ends of the conductive tabs.

The extension portions may include one or more notches, regions, thicknesses, or widths along a length of the extension portion. The extension portions may be shaped or configured to facilitate bending, folding, or manipulation of the conductive tabs to improve a contact surface position for the weld tab, as well as to limit sheering or other forces on the conductive tab. Additionally, the end portions of the conductive tabs may be of different shapes or sizes in embodiments. For example, although the contacts may be of similar size, a battery terminal may be larger or smaller than a circuit board contact in some embodiments. Accordingly, a first end of a conductive tab may be sized to accommodate a contact of the circuit board, while a second end of the conductive tab may be sized to accommodate an electrode terminal of a battery. Hence, any number of variations may be provided by the present technology to accommodate both modules and batteries.

Module 600 may include a coupling 320, which may be coupled with circuit board 312 along a similar surface as the conductive tabs as previously described. Coupling 320 may be electrically coupled with pads 605 using surface mount technology, which may allow electrical coupling with the circuit board. An additional temperature sensitive adhesive 610 may be included to further couple and support coupling 320. A temperature sensitive adhesive may be included to ensure coupling is maintained during coupling with the module, which may include relatively higher temperature processes, which may reduce coupling or damage other adhesives, such as pressure sensitive adhesives.

The second surface of circuit board 312, on which the conductive tabs and coupling 320 may be seated, may be exposed facing away from a battery to which the module 600 is joined, as previously described. Such an exposure may allow access to test points 615 or pads, which may provide diagnostic testing of the power module, system, or battery. Accordingly, in some embodiments an additional molding or covering may not be included across the second surface of the circuit board. The test points may be accessible through or around an outer adhesive as previously described, or removal of the adhesive may provide access to the test points.

Battery systems according to embodiments of the present technology may provide a limited footprint extension for a control module associated with a battery. Because many electronic devices have limited volume for a battery, the present technology allows more of this volume to be used for battery cell material, which may increase or maintain battery capacity in smaller devices. Additionally, while many battery configurations are characterized by uneven external topographies, modules according to some embodiments of the present technology may maintain a substantially even external surface by providing internal mold and component configurations that accommodate the uneven battery characteristics.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A battery system comprising:
a battery, wherein the battery includes a first electrode terminal and a second electrode terminal accessible along a first surface of the battery; and
a module electrically coupled with the battery, the module comprising:
a circuit board characterized by a first surface and a second surface opposite the first surface;
a mold extending from the first surface of the circuit board toward the battery,
a first conductive tab electrically coupling the module with the first electrode terminal, and
a second conductive tab electrically coupling the module with the second electrode terminal, wherein the second conductive tab extends across the mold substantially parallel to the first surface of the circuit board.

2. The battery system of claim 1, wherein the battery further comprises a port positioned proximate a lateral edge of the first surface of the battery, wherein the second conductive tab extends between the mold and the port.

3. The battery system of claim 2, further comprising a first adhesive positioned between the second conductive tab and the mold proximate the port.

4. The battery system of claim 1, wherein the first conductive tab extends beyond a first lateral edge of the module, wherein the second conductive tab extends beyond a second lateral edge of the module opposite the first lateral edge of the module, and wherein the first conductive tab and the second conductive tab extend from the second surface of the module.

5. The battery system of claim 4, wherein the second conductive tab extends about the second lateral edge of the module and wraps across the mold towards the second electrode terminal.

6. The battery system of claim 4, wherein the first electrode terminal extends proud of the first surface of the battery towards the first surface of the circuit board, and wherein the first conductive tab extends past a plane of the second surface of the circuit board to couple with the first electrode terminal.

7. The battery system of claim 1, wherein an electronic device extends from the first surface of the circuit board towards the battery.

8. The battery system of claim 1, wherein the circuit board extends substantially parallel to the first surface of the battery to a location proximate the first electrode terminal.

9. The battery system of claim 1, further comprising an adhesive extending across the module, and wherein a first end of the adhesive and a second end of the adhesive are coupled with the battery.

10. The battery system of claim 9, wherein the adhesive comprises an insulation along a portion of the adhesive, and wherein the insulation extends from a first end of the adhesive across the first electrode terminal.

11. The battery system of claim 1, further comprising a flexible coupling extending from the module and comprising a board-to-board connector at a distal end of the flexible coupling.

12. A battery system comprising:
a battery characterized by a first surface, a second surface, and a third surface, wherein the second surface and the third surface are substantially parallel to one another, wherein the first surface of the battery extends between the second surface and the third surface, and wherein the first surface comprises a first electrode terminal and a second electrode terminal;
a module coupled with the first surface of the battery and comprising a circuit board characterized by a first surface and a second surface opposite the first surface, wherein the module comprises:
a mold extending from the first surface of the circuit board toward the battery,
a first conductive tab extending from the second surface of the circuit board to the first electrode terminal, and
a second conductive tab extending from the second surface of the circuit board to the second electrode terminal; and
a flexible coupling extending from the second surface of the circuit board.

13. The battery system of claim 12, wherein the mold extends laterally parallel with the first surface of the battery, wherein the first electrode terminal of the battery extends from the first surface of the battery, and wherein the mold is maintained between the first electrode terminal of the battery and a lateral edge of the battery.

14. The battery system of claim 12, wherein the second conductive tab extends about a lateral edge of the module and wraps across the mold towards the second electrode terminal.

15. The battery system of claim 14, wherein the second conductive tab is coupled with the mold by a first adhesive, and wherein the second conductive tab is coupled with the battery by a second adhesive.

16. The battery system of claim 12, wherein the second surface of the battery comprises a flange extending proud of an intersection of the first surface of the battery and the second surface of the battery, and wherein the circuit board of the module extends substantially parallel to the first surface of the battery between the flange and the third surface of the battery.

17. The battery system of claim 12, wherein the module extends across the second electrode terminal of the battery.

18. The battery system of claim 12, wherein the circuit board comprises test points accessible on the second surface of the circuit board.

19. The battery system of claim 12, wherein the flexible coupling comprises a connector at a distal end of the flexible coupling, and wherein the flexible coupling is coupled with the second surface of the circuit board at a proximal end of the flexible coupling.

20. A battery system comprising:
a battery, wherein the battery includes a first electrode terminal, a second electrode terminal, and a port accessible along a first surface of the battery;
a module electrically coupled with the battery, the module comprising:
a mold extending toward the battery, wherein the mold extends across the second electrode terminal and the port between the first electrode terminal and a lateral edge of the battery,
a first conductive tab electrically coupling the module with the first electrode terminal, and
a second conductive tab electrically coupling the module with the second electrode terminal, wherein the second conductive tab extends from a surface of the module opposite the mold, and wherein the second conductive tab extends about a lateral edge of the module across the mold and between the mold and the battery;
a flexible coupling extending from the module from a surface of the module opposite the mold; and
an adhesive positioned between the mold and the second conductive tab.
